(19) United States
(12) Patent Application Publication
(10) Pub. No.: US 2008/0081543 A1
(43) Pub. Date: Apr. 3, 2008

(54) Water-based non-organic coolant for texturing hard disk

(75) Inventor: Andu Alem Tefera, Sunnyvale, CA (US)

Correspondence Address: BEYER WEAVER LLP, P.O. BOX 70250, OAKLAND, CA, 94612-0250, US

(73) Assignee: MIPOX International Corporation

(21) Appl. No.: 11/540,777

(22) Filed: Sep. 29, 2006

(51) Int. Cl. B24B 7/30; C09K 5/00

(52) U.S. Cl. 451/41; 252/71

(57) ABSTRACT

A water-based non-organic coolant contains a texturing surfactant, a wetting surfactant, a lubricating surfactant and a bacterial growth inhibitor each of a specified composition and each in an amount within a specified range. As a hard disk is rotated, slurry containing abrading particles and such a coolant is applied to its surface as a polishing tape is pressed on it to obtain a textured surface of a high quality.

### BACKGROUND OF THE INVENTION

This invention relates broadly to the polishing and texturing of a rigid disk such as a hard disk drive as a high-density recording medium and more particularly to a water-based non-organic coolant that is effective in such a process.

It has been known to add an abrasive material and powder to a coolant to make slurry to be used with a specially prepared tape for two purposes: a) to make a mirror finish smooth surface for advanced deposition of magnetic materials by sputtering and b) to create circumferential texturing lines for the deposition of magnetic materials by sputtering. For producing a magnetic recording medium such as a hard disk drive, an aluminum substrate may be dipped in NiP and then polished to make its surface as flat and smooth as possible. The substrate is then taken to a polishing machine and then to a texturing machine where its surface is prepared for the deposition of magnetic materials by sputtering. Preparing the surface of a rigid disk is an important step for a high-end, high-density rigid disk that is used for memory storage. In the polishing process, the surface of the substrate is made as flat and smooth as possible and the substrate is made very close to the desired thickness. The NiP coating is polished to bring the variation in thickness to a minimum and the smoothness made as uniform as possible throughout the surface area. For this polishing process, a coolant with abrasive particles added to it is used to remove some stock and reduce the thickness to the desired level. In the texturing process, the substrate is mounted on a spindle and rotated at a high rate. Tapes are fed and run parallel to the surface of the rotating substrate. On both surfaces of the substrate, rollers may be pressed onto the tapes to rub the surfaces of the substrate. At the same time, slurry is dropped into the tapes to be carried to the contact areas between the substrate and the tapes. The coolant is a liquid solution that carries the abrasive particles and the slurry is used to prepare the surfaces of the substrate.

The surfaces of the substrate after it is dipped in NiP are rough and wavy. In the polishing process, the substrate is thinned with the help of the coolant and the abrading particles. Lines that are created on the substrate by this process are not those that are eventually to be considered needed.

For so-called perpendicular magnetic recording, the substrate surfaces need to be as smooth as possible. So, these lines resulting from the polishing process are eliminated by the texturing process. For so-called longitudinal magnetic recording, these lines must also be eliminated and circumferential lines are created in their place. These circumferential lines form diamond-shaped mountains and valleys that allow magnetic deposits to be stored in the valleys.

A coolant is used in the slurry for the following purposes. Firstly, it is used to suspend, distribute and carry the abrading particles such as diamond powder. Secondly, it is used to wet, lubricate and clean the surface of the substrate. Thirdly, it is used to dissolve and clean the stock removed in the process. Fourthly, it is used to fight fungal and bacterial growth in the slurry. Fifthly, it is used to keep the pH value of the slurry balanced close to neutral.

For the polishing process, the coolant serves with abrasive particles added to provide a consistently uniform thickness to the substrate and to remove stock through the surface without creating waviness. The limiting factor is the capacity of the polishing machine being used and the size and distribution of the abrasive particles.

Depending upon the size of the abrading particles (or powder) and the other process conditions, the coolant may give a surface finish on the order of 0.50 Å to 3.0 Å in the texturing process. By varying the type of the polishing tape, the size of the abrading particles and the other conditions of the process, the same coolant can be used to get programs defined in the range given above.

Smaller disks are coming to be used for longitudinal magnetic recording programs. Most important requirements for such disks include creating consistently more lines in a very small area and keeping this area extremely clean. Accordingly to currently used technology, organic components extracted from oil-producing seeds are used as coolants. These fatty acids create problems because they leave residues after the texturing process. As the memory density on these memory media increases, the role of even small defects on the disk surface become magnified. It is not desirable to use chemicals in the washing process because of possible damage to the surface and possible reactions in the sputtering process. Thus, a water-based non-organic coolant is becoming desirable.

### SUMMARY OF THE INVENTION

It is a general object of this invention to provide an improved method of texturing a hard disk.

It is a specific object of this invention to provide a water-based non-organic coolant for texturing a hard disk.

A water-based non-organic coolant of this invention is characterized as being a solution containing a texturing surfactant, a wetting surfactant, a lubricating surfactant and a bacterial growth inhibitor each of a specified composition and each in an amount within a specified range. The texturing surfactant is sodium tripolyphosphate and is contained at a rate of 0.50%-1.50%. The wetting surfactant is polyoxyethylene and is contained at a rate of 1.5%-2.0%. The lubricating surfactant is preferably polyalkylene and is contained at a rate of 1.8%-2.3%. The bacterial growth inhibitor is benzyldimethylhexadecyl ammonium chloride and is contained at a rate of 0.05%-0.10%. These components are mixed in 94%-97% of deionized water.

Other compounds such as polyethylene glycol nonylphenyl ether, ethylene oxide and propylene oxide polymer may be additionally contained.

A texturing method according to this invention is characterized as comprising the steps of rotating a hard disk, spraying slurry made of a coolant of this invention and abrading particles on a surface of this hard disk, and pressing a tape on this surface while the hard disk is rotated.

### BRIEF DESCRIPTION OF THE DRAWINGS

FIG. 1 is a micromax visual picture of circumferential lines on the surface of a hard disk textured by a method of this invention.

FIG. 2 is an atomic force microscope (AFM) picture showing circumferential lines on the surface of a hard disk textured by a method of this invention.

FIG. 3 is an AFM three-dimensional picture of the circumferential lines of FIG. 2.

### DETAILED DESCRIPTION OF THE INVENTION

The invention relates to a water-based non-organic coolant characterized as containing a texturing surfactant, a wetting surfactant, a lubricating surfactant and a bacterial growth inhibitor each of a special kind and each in an amount within a specified range. The texturing surfactant is preferably sodium tripolyphosphate and is contained at a rate of 0.50%-1.50% and preferably by about 0.10%.

The wetting surfactant is preferably polyoxyethylene and is contained at a rate of 1.5%-2.0% and preferably by about 1.8%. It may additionally contain polyethylene glycol and/or dinonylphenyl polyoxyethylene.

The lubricating surfactant is preferably polyalkylene and is contained at a rate of 1.8%-2.3% and preferably by about 2.12%. It may additionally contain propylene glycol and/or propylene oxide polymer.

The bacterial growth inhibitor is benzyldimethylhexadecyl ammonium chloride (CH₃(CH₂)₁₅N(Cl)(CH₃)₂CH₂C₆H₅) and is contained at a rate of 0.05%-0.10% and preferably by a bout 0.08%

These components are dissolved in 94%-97% of water or preferably deionized water.

If the content of the texturing surfactant is below the stated range, conglomerations of abrading particles will occur. If it is over the stated range, on the other hand, the intended effects of the other components will be overpowered and neutralized.

If the content of the wetting surfactant is below the stated range, the contact on the disk surface will not be established and stock removed efficiently. If it is over the stated range, on the other hand, the other components will become ineffective.

If the content of the lubricating surfactant is below the stated range, the stock removal of the coolant will be adversely affected after freezing and thawing. If it is over the stated range, there will be more deep cuts and valleys as the result of the texturing.

If the content of the bacterial growth inhibitor is below the stated range, bacterial or fungal growth will occur. If it is over the stated range, pits and unwanted blisters will come to be observed on the treated surface.

The invention relates also to a method of texturing a hard disk. A prior art texturing machine of a known type provided with a spindle to which a disk may be mounted and nozzles for supply a liquid may be used for the purpose of this invention. A method according to this invention may be characterized as comprising the steps of rotating a hard disk, preparing-slurry by mixing a coolant of this invention with abrading particles having diameters in the range of 0.10 nm-0.15 nm on a surface of this hard disk and pressing a running tape on the surface while the hard disk is rotated.

In a typical texturing process as explained above, the hardness of the rollers with which the tape is pressed may be 30-60 durometer, the force by the rollers may be 1.0-4.0 lbs, the supply speed of the polishing tapes may be 1.5-3.0 inches/minute, the rotary speed of the hard disk may be 300-1600 rpm, the tension in the tapes may be 0.5-1.5 lbs, the oscillation frequency may be 4.0-5.0 Hz, the oscillation amplitude may be 0.05-0.1 inch, the time of texturing process may be 7.0-15 seconds and the slurry flow rate may be 10.0-30 ml/minute. These, however, are merely examples and are not intended to limit the scope of the invention.

The invention is explained next by way of results of experiments performed by using the coolant and the method of this invention. Sample hard disk substrates were textured by using a texturing machine of a known type by applying slurry made of a coolant of this invention together with three different kinds of diamond abrading particles having diameters 0.10 nm, 0.12 nm and 0.15 nm. In all experiments, the texturing time was less than 10 seconds.

Table 1 shows the average surface roughness Ra, maximum roughness Rmax, peak ridge height Rp, deep of valley Rv and line density of texturing marks on the sample substrates.

Table 2 shows the measured values of stock removal as diamond abrading particles having diameters 0.10 nm were used in the slurry in 5 minutes of texturing process.

TABLE 1

| | Diameter of | | | | | |
|---|---|---|---|---|---|---|
| Disk | abrading | Ra | Rmax | Rp | Rv | Line density |
| No. | particles (nm) | (Å) | (Å) | (Å) | (Å) | (μm) |
| 1 | 0.10 | 1.96 | 29.34 | 13.39 | −15.95 | 25.800 |
| 2 | 0.10 | 1.88 | 40.89 | 27.44 | −13.45 | 22.990 |
| 3 | 0.10 | 1.83 | 35.95 | 23.99 | −11.96 | 20.440 |
| 4 | 0.10 | 2.05 | 47.77 | 33.82 | −13.95 | 19.596 |
| 1 | 0.12 | 1.60 | 35.09 | 14.08 | −21.01 | 20.800 |
| 2 | 0.12 | 1.37 | 48.62 | 35.45 | −13.17 | 21.400 |
| 3 | 0.12 | 2.40 | 44.85 | 21.05 | −13.69 | 20.437 |
| 4 | 0.12 | 2.27 | 40.80 | 17.44 | −23.37 | 15.900 |
| 1 | 0.15 | 3.45 | 57.51 | 32.08 | −25.43 | 20.943 |
| 2 | 0.15 | 3.25 | 72.83 | 34.57 | −38.26 | 24.897 |
| 3 | 0.15 | 2.80 | 50.94 | 29.05 | −21.89 | 19.137 |
| 4 | 0.15 | 3.02 | 46.79 | 29.05 | −19.06 | 18.400 |

TABLE 2

| | Weight before | Weight after texturing | Difference |
|---|---|---|---|
| Disk No. | texturing (gr) | (gr) | (gr) |
| 1 | 23.021 | 23.015 | 0.006 |
| 2 | 23.015 | 23.008 | 0.007 |
| 3 | 23.018 | 23.010 | 0.008 |
| Average | 23.018 | 23.011 | 0.007 |
| Standard deviation | 0.003 | 0.004 | 0.001 |
| Maximum | 23.021 | 23.015 | 0.008 |
| Minimum | 23.015 | 23.008 | 0.006 |

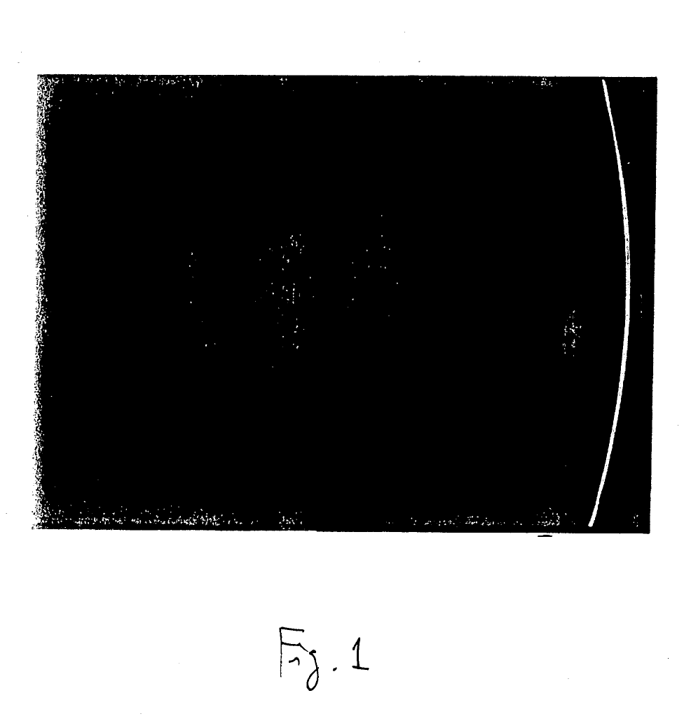

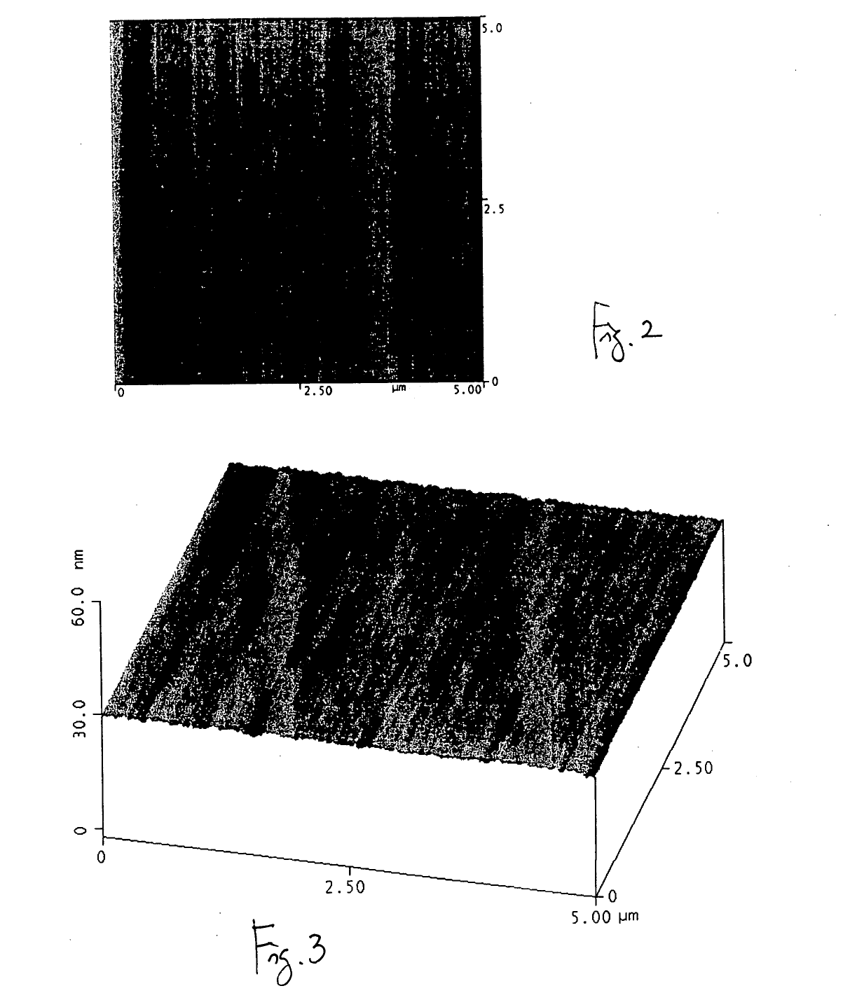

FIG. 1 is a micromax visual picture of circumferential lines on the surface of a hard disk textured by a method of this invention. FIG. 2 is an atomic force microscope (AFM) picture showing circumferential lines on the surface of a hard disk textured by a method of this invention. FIG. 3 is an AFM three-dimensional picture of the circumferential lines of FIG. 2. FIGS. 1-3 and Table 1 and 2 clearly show that texturing lines of a high quality can be formed on the surface of a

In summary, the experiments have shown that the coolants according to this invention wet the hard disk surface easily, carry the abrading particles to the tape and easily wash off the disk surface without the use of any chemical, in addition to having the merit of inhibiting bacterial and fungal growth.

What is claimed is:

1. A water-based non-organic coolant comprising:
sodium tripolyphosphate by 0.50%-1.50%;
polyoxyethylene by 1.5%-2.0%;
polyalkylene by 1.8%-2.3%;
benzyldimethylhexadecyl ammonium chloride by 0.05%-0.10%; and
deionized water by 94%-97%.

2. The water-based non-organic coolant of claim 1 further including polyethylene glycol nonylphenyl ether.

3. The water-based non-organic coolant of claim 1 further including ethylene oxide.

4. The water-based non-organic coolant of claim 1 further including propylene oxide polymer.

5. A method of texturing a hard disk, said method comprising the steps of:
rotating said hard disk;
spraying slurry made of a coolant and abrading particles on a surface of this hard disk; and
pressing a tape on said surface while said hard disk is rotated; wherein said coolant comprises:
sodium tripolyphosphate by 0.50%-1.50%;
polyoxyethylene by 1.5%-2.0%;
polyalkylene by 1.8%-2.3%;
benzyldimethylhexadecyl ammonium chloride by 0.05%-0.10%; and
deionized water by 94%-97%.

6. The method of claim 5 wherein said abrading particles have diameters of 0.10 nm-0.15 nm.

7. The method of claim 5 wherein said coolant further includes polyethylene glycol nonylphenyl ether.

8. The method of claim 5 wherein said coolant further includes ethylene oxide.

9. The method of claim 5 wherein said coolant further includes propylene oxide polymer.
